(19) United States
(12) Patent Application Publication
(10) Pub. No.: US 2018/0285818 A1
(43) Pub. Date: Oct. 4, 2018

(54) COLLABORATION PLATFORM

(71) Applicant: INERSI INC., Toronto (CA)

(72) Inventor: Reza SOLTANI, Mississauga (CA)

(21) Appl. No.: 15/944,987

(22) Filed: Apr. 4, 2018

Related U.S. Application Data
(60) Provisional application No. 62/481,376, filed on Apr. 4, 2017.

(51) Int. Cl. G06Q 10/10; G06Q 50/00; G06F 17/30

(52) U.S. Cl. CPC G06Q 10/101; G06F 17/30958; G06Q 50/01

(57) ABSTRACT

Example embodiments described herein relate to an online social content collaboration platform that allows user devices to access content and create derivative works of content. A graph structure defines content and derivative works as nodes and relationships or links between the content and derivative works as edges. The content and relationships for the content may be displayed to user device as an interface of visual elements in the form of the graph structure of nodes and edges. Example embodiments described herein relate to an online social content collaboration platform that allows user devices to access content and create derivative works of content and get rewarded. The rewards can be cryptographic tokens.

### FIELD

The improvements generally relate to the field of online social collaboration.

### INTRODUCTION

Users may upload content to social platforms to share the content. Other users may want to modify the shared content to generate new content. Content may be subject to usage restrictions that limit permitted use of the content.

### SUMMARY

In accordance with an aspect, there is provided a platform, process and device for online social collaboration that allows users to access, create and modify content.

In accordance with an aspect, there is provided an online social content collaboration platform with a processor and a memory storing computer executable instructions to configure the processor to: receive or access content from a first user device; create derivative work of the content in response to commands from a second user device; store the derivative work at the memory; generate a graph structure of first node for the content and a second node for the derivative work and a first edge between the first node for the content and the second node for the derivative work; store the graph structure at the memory; and generate an interface for display on a display device, the interface having visual elements representing the content, the derivative work, and the graph structure of the first node, the second node, and the first edge.

In some embodiments, the processor is further configured to receive a search request from the second user device and provide an indication of the content in response to the search request.

In some embodiments, the processor is further configured to: create a second derivative work of the content in response to commands from a third user device; store the second derivative work at the memory; update the graph structure with a third node for the second derivative work and a second edge between the first node for the content and the third node for the second derivative work; store the updated graph structure at the memory; and update the interface with additional visual elements representing the second derivative work, and the updated graph structure with the third node, and the second edge.

In some embodiments, the processor is further configured to: create a second derivative work of the derivative work in response to commands from a third user device; store the second derivative work at the memory; update the graph structure with a third node for the second derivative work and a second edge between the second node for the derivative work and the third node for the second derivative work; store the updated graph structure at the memory; and update the interface with additional visual elements representing the second derivative work, and the updated graph structure with the third node, and the second edge.

In some embodiments, the processor is further configured to: receive a reward amount from the first user device as an incentive for the derivative work; and distribute the reward amount to the second user in response to the creation of the derivative work.

In some embodiments, the processor is further configured to receive a first tag for the content and second tag the derivative work; and update the interface with additional visual elements for the first tag and the second tag.

In some embodiments, the processor is further configured to receive a first comment for the content and second comment the derivative work; and update the interface with additional visual elements for the first comment and the second comment.

In some embodiments, the processor is further configured to generate a first user profile linked to the content and a second user profile linked to the derivative work; update the graph structure with a first reference in the first node to the first user profile and a second reference in the second node to the second user profile.

In some embodiments, the processor is further configured to receive an update to the content and update the interface with the updated content.

In some embodiments, the processor is further configured to receive an update to the derivative work and update the interface with the updated derivative work.

In some embodiments, the processor is further configured to compare the content to the derivative work to generate comparison output and update the interface with an indication of the comparison output.

In some embodiments, the processor is further configured to receive interactions selected from: one or more of viewing the first edge between the content and the derivative work, searching for the content, comparing the content and the derivative work using a data processing tool, amending or modifying the content or the derivative work, creating content or the derivative work, commenting on the content or the derivative work, tagging the content or the derivative work with metadata, managing profile settings, and generating configurations for the interface to display different perspectives of the visual elements.

In some embodiments, each node in the graph structure includes an identifier for the content or the derivative work, user identifier for the user device that created the content or the derivative work, and time data for the creation of the content or the derivative work, wherein the first edge include an identifier for one or more parent nodes and an identifier for one or more child nodes in the graph structure.

In another aspect, there is provided an online social content collaboration process involving: at a processor, receiving or accessing content from a first user device; creating derivative work of the content in response to commands from a second user device; generating a graph structure of first node for the content and a second node for the derivative work and a first edge between the first node for the content and the second node for the derivative work; storing the graph structure at a memory; and generating an interface for display on a display device, the interface having visual elements representing the content, the derivative work, and the graph structure of the first node, the second node, and the first edge.

In some embodiments, the process involves receiving a search request from the second user device and provide an indication of the content in response to the search request.

In some embodiments, the process involves creating a second derivative work of the content in response to commands from a third user device; updating the graph structure with a third node for the second derivative work and a second edge between the first node for the content and the third node for the second derivative work; storing the updated graph structure at the memory; and updating the interface with additional visual elements representing the second derivative work, and the updated graph structure with the third node, and the second edge.

In some embodiments, the process involves creating a second derivative work of the derivative work in response to commands from a third user device; storing the second derivative work at the memory; updating the graph structure with a third node for the second derivative work and a second edge between the second node for the derivative work and the third node for the second derivative work; storing the updated graph structure at the memory; and updating the interface with additional visual elements representing the second derivative work, and the updated graph structure with the third node, and the second edge.

In some embodiments, the process involves receiving a reward amount from the first user device as an incentive for the derivative work; and distributing the reward amount to the second user in response to the creation of the derivative work.

In some embodiments, the process involves receiving an update to the derivative work and updating the interface with the updated derivative work.

In some embodiments, the process involves comparing the content to the derivative work to generate comparison output and updating the interface with an indication of the comparison output.

In accordance with an aspect, there is provided an online social content collaboration platform that allows a user device to upload or access content and create derivative works of the content, wherein the platform generates a graph structure of nodes for the content and derivative works and edges for links between the content and the derivative works, the platform generates an interface on the user device, the interface having visual elements in the form of the graph structure of nodes and edges.

In accordance with an aspect, there is provided an online social content collaboration platform that allows a user device to interact with content and create derivative works of the content, wherein the platform generates a graph structure of nodes for the content and derivative works and edges for links between the content and the derivative works, the platform generates an interface on the user devices for such interactions, the interface having visual elements in the form of the graph structure of nodes and edges.

In some embodiments, the interactions involve one or more of viewing the links between the content or the derivative works, searching for the content, comparing the content and the derivative works using a data processing tool, amending or modifying the content or the derivative works, creating content or the derivative works, commenting on the content or the derivative works, tagging the content or the derivative works with metadata, managing profile settings, generating configurations for the interface displaying different perspectives of the visual elements, and other interactions. In some examples content is an initial work on which a derivative work is based. Content can include initial works, derivative works or a combination of both.

In some embodiments, each node in the graph structure includes an identifier for the content or the derivative works, user identifier for the user device that created the content or the derivative works, and time data for the creation of the content or the derivative works, wherein the edges include an identifier for one or more parent nodes and an identifier for one or more child nodes in the graph structure. In some example embodiments there may be multiple parent nodes. Accordingly, an edge can include multiple identifiers for multiple parent nodes.

Many further features and combinations thereof concerning embodiments described herein.

### DESCRIPTION OF THE FIGURES

Embodiments will now be described, by way of example only, with reference to the attached figures, wherein in the figures:

FIG. 1 is a diagram of an example platform for online social content collaboration according to some embodiments described herein;

FIG. 2 is a diagram of an environment for an example platform for online social content collaboration according to some embodiments described herein;

FIG. 3 is a diagram of an architecture for an example platform for online social content collaboration according to some embodiments described herein;

FIG. 4 is a diagram of a workflow for an example process for online social content collaboration according to some embodiments described herein;

FIG. 5 is a diagram of an example interface with visual elements for a slide perspective of a graph structure representing content from an example platform for online social content collaboration according to some embodiments described herein;

FIG. 6 is a diagram of an example interface with visual elements for a graph perspective of a graph structure representing content from an example platform for online social content collaboration according to some embodiments described herein;

FIG. 7 is a diagram of an example interface with visual elements for a tunnel perspective of a graph structure representing content from an example platform for online social content collaboration according to some embodiments described herein;

FIG. 8 is a diagram of an example interface with visual elements for a dialog box of an example platform for online social content collaboration according to some embodiments described herein;

FIG. 9 is a diagram of a workflow for an example process for obtaining a post for online social content collaboration according to some embodiments described herein;

FIG. 10 is a diagram of a workflow for an example process for creating a post for online social content collaboration according to some embodiments described herein;

FIG. 11 is a diagram of a computing device for implementing aspects of an example online social content collaboration platform according to some embodiments described herein;

FIG. 12 is a diagram of an interface for online social content collaboration according to some embodiments described herein; and

FIG. 13 is a diagram of a workflow for an example process for incentives.

### DETAILED DESCRIPTION

Embodiments of methods, systems, and apparatus are described through reference to the drawings.

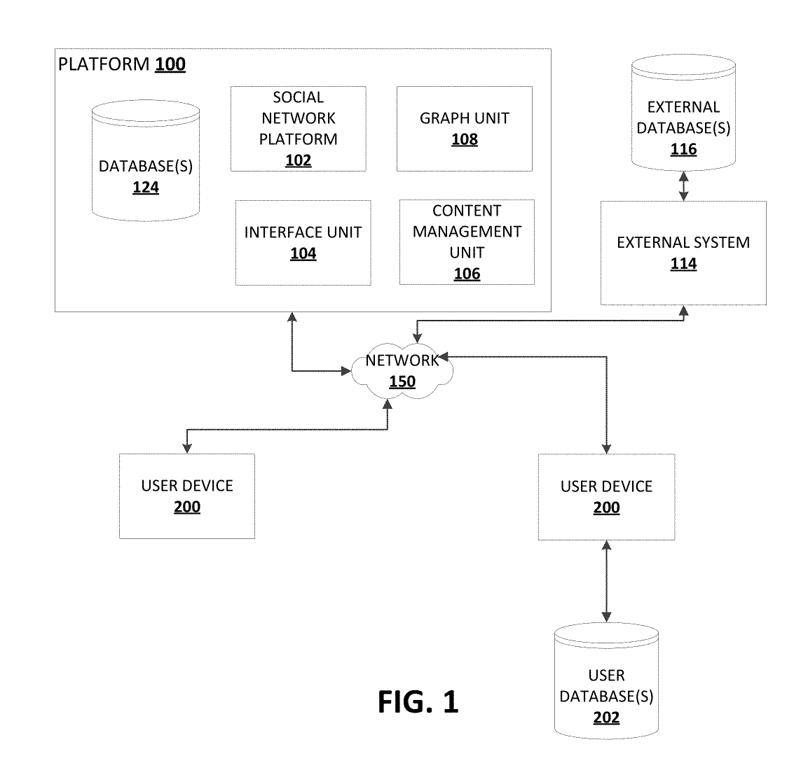

FIG. 1 is a diagram of an example online platform 100. The platform 100 may be referred to as an online social content collaboration platform 100 or more generally, platform 100. In some embodiments, platform 100 allows user device 200 to share or access content. Content may be accessible to user device 200 in a display of posts and information relating to one or more relationships between or amongst posts. For example, posts and relationships amongst the posts may be displayed to user device 200 in the form of a graph structure, where one or more posts are presented as directly associated with or connected to one or more other posts.

Content or posts may be digital images, videos, text, or a combination thereof. Content may also include data that may be used to present or display the digital images, videos, text, or a combination thereof. Platform 100 includes an interface unit 104 to connect to user device 200 via network 150 to receive content. Interface unit 104 can also receive content and amendments (e.g. modifications or changes), tags or annotations to content from external system 114 and external databases 116.

A content management unit 106 manages content received from user device 200 (or user database 202) by including a link between the content and the user device 200 the content was received from. Content management unit 106 may include a content editor tool for user device 200 to make amendments (e.g. modifications or changes), tags or annotations to content. The user device 200 may be the same or different user device 200 that the content was originally received from. Content management unit 106 manages amendments (e.g. modifications or changes), tags or annotations to content by generating new content based on the amendments, tags or annotations and linking the new content to the original content and the user device 200 that the amendments, tags or annotations were received from. Graph unit 108 manages and uses the links between the user devices 200 and content to generate or define a graph structure for the relationships between the content (e.g. new content and the original content) and the user devices 200. Social network platform 102 defines a social network between users associated with one or more user devices 200. Graph unit 108 generates the graphs structures for the relationships between posts (content). Graph unit 108 also generates the graphs structures with a link between each user and each post because each post is generated (uploaded or edited online) by a particular user of the platform 100 through user device 200. In some embodiments, the graph structure only includes connections between posts or content and not users for example. In some embodiments, the graph structure includes connections between posts and users. In some embodiments, graph unit 108 generates links between users of the platform in a simple relational or document type database. Graph unit 108 may maintain the relationships (e.g., friendships) among users within a graph database.

Content or posts may include derivative works of content or posts. Derivative works may refer to content or posts that one or more user devices 200 have modified, amended, tagged, edited, annotated, or caused association with data. For example, content may be a digital image and a derivative work may be a modification to the digital image. Every amendment, tag, edit, annotation, change, association with data, iteration of, or input received from user device 200 and relating to or applied to a first post, first content, or derivative thereof may be saved or stored in database 124. Content management unit 106 creates links between the derivative work and the content the derivative work was made from. Graph unit 108 uses the links to generate a graph structure connecting nodes representing content and derivative works to define relationships between the content and the derivative work. For example, image A may be used to generate derivative work A which in turn may be used to generated derivative work B. Image A may also be used to generate derivative work C. Content management unit 106 creates a link between image A and derivative work A, a link between derivative work A and derivative work B, and a link between image A and derivative work C. Graph unit 108 generates a graph structure of nodes representing the content (included derivative works) and edges between nodes representing links between the content. Interface unit 104 is configured to generate a graphical representation of the graph structure of nodes and edges for display on user device 200.

The derivative work may be represented as a new or separate instance or node of the first post, first content, or first derivative. For example, the new or separate instance or node is a derivative of the first post, first content, or first derivative. Content management unit 106 creates a link between the new node and the node representing the first content. In some embodiments, the derivative work includes an amended, tagged, edited, or annotated version of the first post, first content, or first derivative. In some embodiments, the derivative work includes only an amendment, tag, edit, annotation, or data enabling construction of an amended, tagged, edited, or annotated version of the first post, first content, or derivative work.

The platform 100 may use links between content and derivative works to help avoid conflict issues related to two or more user devices 200 engaging with or amending the same post, content, derivative of same, or portion or feature of same. The platform 100 may use links between content and derivative works to show or trace relationships between content and derivative works.

A derivative work may be referred to as a child node of content. The content used to make the derivative work may be referred to as a parent node. Each derivative of said child node and each derivative of each descendant of said child may be each referred to as a descendant node. Graph unit 108 generates a graph structure of child nodes, descendant nodes, and parent nodes. A post or content having one or more derivative works may be referred to as a parent node, and a post or content having two or more derivative works may be referred to as an ascendant node. Graph unit 108 generates a graph structure of all posts, content, and derivative works of same that are related to each other, for example, all parent nodes, child nodes, ascendant nodes, and descendant nodes of a post and all parents, children, ascendants, and descendants of same. Graph unit 108 can also generate a graph structure of a subset of posts, content, and derivative works of same that are related to each other. Platform 100 may support a multiplicity of graphs and graph unit 108 can generate different graph structures using different sets of nodes.

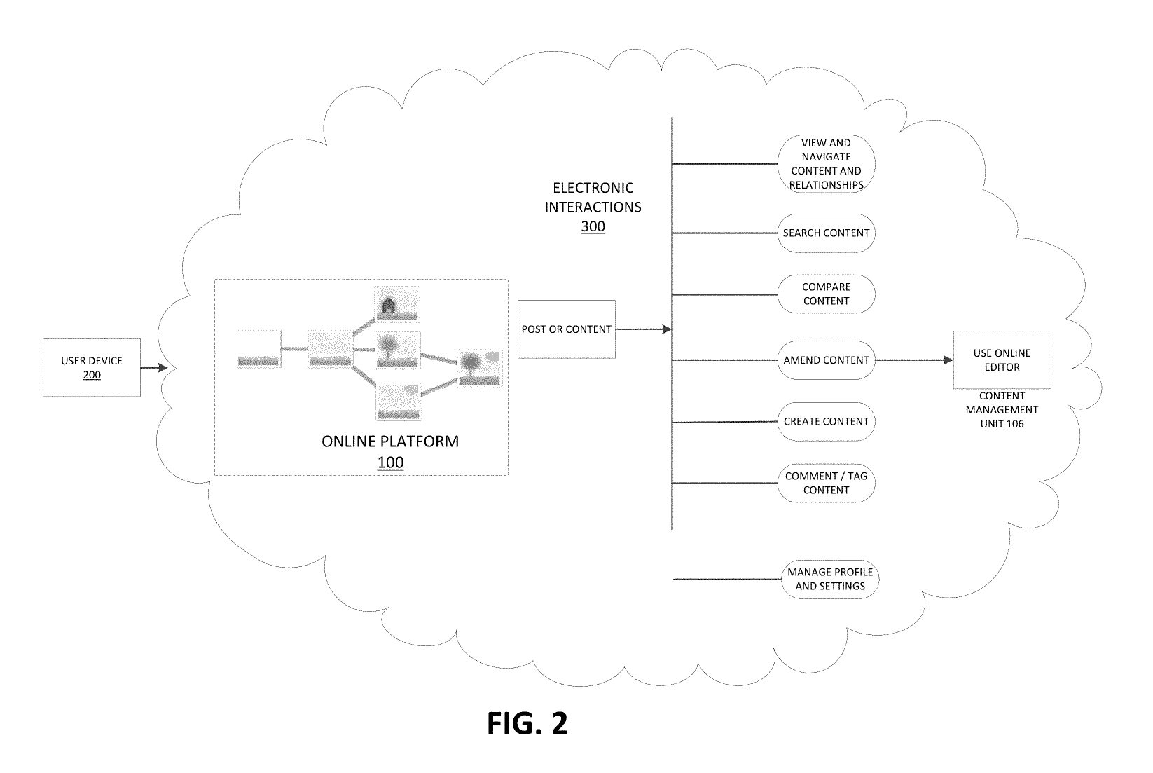

FIG. 2 is a diagram of an example online platform 100 which may be referred to as online social collaboration platform 100. In some embodiments, user device 200 may generate an electronic interaction 300 with online social collaboration platform 100 by uploading posts or content; viewing posts, content, or derivative posts or content; alter content on platform 100, for example, to produce derivative works viewable by user devices 200 engaging with the platform 100; navigate or display a portion of or all of one or more graph structures (generated by graph unit 108); zoom in or zoom out of one or more posts or content; cause one or more comments, tags, or data to be associated with one or more posts or content; compare a portion of one or more graph structures with one or more other portions of or entire graph structures; compare one or more entire graph structures with one or more other portions of or entire graph structures; compare one or more posts or content with one or more other posts or content; engage with an online editor associated with or included in an online platform 100; create one or more online profiles; save or set data or settings, for example, associated with the user's 200 preferences relating to privacy of a specific post, privacy of all content or posts associated with the user device 200, usage restrictions for content, or settings related to said user's 200 account; or cause data, for example, content, posts, or related information, to be transmitted or saved by online platform 100 or associated architecture. In some embodiments, a user device 200 may submit or create revisions to content, posts, or derivative works of same. A revision may be stored as a new node with a link to the underlying content. The links may be stored in databases 124 for use in generating graph data structures. Graph unit 108 generates a graph data structure of nodes and edges according to one or more links to or relationships with other nodes, for example, as a derivative of the one or more other nodes. A revision may be accessible by one or more other user devices 200, and one or more other user devices 200 may comment, tag, describe, or compare a first revision or a first revised post, content, or derivative work of same with a second revision or a second revised post, content, or derivative of same. One or more revisions may be accessible by user devices 200 engaged with platform 100 through interface unit 104 (e.g. web interface). Revisions, content, posts, or derivative works may be shared by user devices 200 with one or more social media sites. Platform 100 connects to social media sites using social network platform 102.

For example, a user device 200 may add a post, content, or derivative work of same to platform using content management unit 106 and interface unit 104. The interface unit 104 is configured to control the display of content and derivative works on user device 200 along with user interface elements to make amendments, tags or revisions to content via content management unit 106. A user device 200 may engage with an “add” dialog box generated by interface unit 104.

The online platform 100 can be an online social collaboration platform, which has the ability to host contents in multiple formats including image, design files (i.e. CAD files), videos and text. The users of the platform 100 can upload their creative work to the online platform 100. Users are able to upload their own original content or alter existing content on the online platform 100 to produce new derivative content items. The original posts along with all of their derivatives are viewable by users of the online platform 100 provided that the access policy is set to public. As shown, online platform 100 can generate a visual representation of an underlying data structure that can be a graph structure or tree structure representation of the content items or posts. The posts can be displayed to the users in the form of tree structures (more technically graph structures).

In general, nodes within a graph can have multiple parent nodes and multiple children nodes, whereas a node within a tree is restricted to having one parent node. For the online platform 100, a post can have multiple parent posts, meaning a post can be derived from multiple existing posts. However to facilitate understanding of the concepts, the term ‘Tree’ is used herein to describe the structure in which contents are presented. Users are able to search and navigate the visual representation or trees, zoom in and zoom out of the trees, comment and tag the posts or trees. Users are also able to compare individual posts, the entire, or portion of a tree structure. The visual representation is updated by the online platform 100 in response to the interactions or user commands. Users have the ability to create their online profile and configure their account settings. These settings consist of (but are not limited to) privacy and security settings.

The online platform 100 has a processor and a memory storing computer executable instructions to configure the processor to receive or access content from a first user device. The online platform 100 can create derivative work of the content in response to commands from a second user device; store the derivative work at the memory. The online platform 100 can generate a graph structure of first node for the content and a second node for the derivative work and a first edge between the first node for the content and the second node for the derivative work. The online platform 100 can store the graph structure at the memory. The online platform 100 can generate an interface for display on a display device. The interface is interactive and dynamically updates visual elements in response to user commands and new content or derivative works. The interface has visual elements representing the content, the derivative work, and the graph structure of the first node, the second node, and the first edge, for example.

The online platform 100 can receive a search request from the second user device and provide an indication of the content in response to the search request.

The online platform 100 can create a second derivative work of the content in response to commands from a third user device. The online platform 100 can store the second derivative work at the memory. The online platform 100 can update the graph structure with a third node for the second derivative work and a second edge between the first node for the content and the third node for the second derivative work. The online platform 100 can store the updated graph structure at the memory. The online platform 100 can update the interface with additional visual elements representing the second derivative work, and the updated graph structure with the third node, and the second edge. That is, the interface updates to reflect the new work and indicates the relationship to the parent work or content, along with other works.

The online platform 100 can create a second derivative work of the derivative work in response to commands from a third user device. The online platform 100 can store the second derivative work at the memory. The online platform 100 can update the graph structure with a third node for the second derivative work and a second edge between the second node for the derivative work and the third node for the second derivative work. The online platform 100 can store the updated graph structure at the memory. The online platform 100 can update the interface with additional visual elements representing the second derivative work, and the updated graph structure with the third node, and the second edge.

Given that the online platform 100 data is stored as graph data structures it is possible to apply graph theory processes to perform useful operations on the data. These operations include, for example: Automatic ranking of posts; Users are able to rate the posts; Applying graph theory processes to rate a derivative posts based on the rank of its parents; Pattern detection; Smart navigation; Use of Shortest path and longest path algorithms to assist user in navigating through the most suitable path.

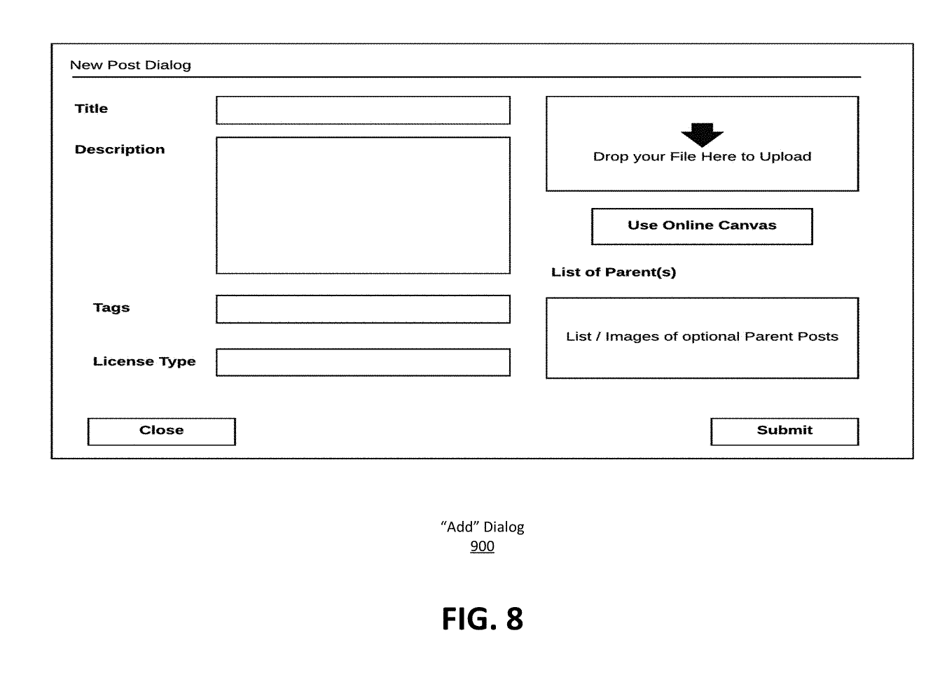

FIG. 8 is a diagram of interface on user device 200 that is controlled by interface unit 104. The interface includes an example “add” dialog 900 interface element that triggers the generation of a new post from content. A user device 200 may engage with the “add” dialog 900 interface element to select a method of adding a post or content, for example, by uploading from local or remote storage (e.g. user database 202), by creating a post or content using an online editor (e.g. content management unit 106), or by using the online editor to alter one or more posts or content already associated with platform 100; to add a post, content, or derivative of same; form fields to provide data input, for example, details, title, description, and tags, related to the post or content; to engage with an online editor to create a post, content, or derivative of same; to indicate one or more posts or content to have one or more parent relationships with an added post or content; or to indicate the nature of a license, usage restriction or copyright associated with an added post or content. The “add” dialog 900 interface element also includes a form field for identifying parent nodes or content used to generate the new post (child node).

In a further example, a user device 200 may edit a post, content, or derivative of same. A user device 200 may engage with an “edit” dialog box of interface (controlled by interface unit 104) to change or update data associated with a post, content, or derivative of same. For example, the “edit” dialog box of interface has form fields to receive textual information such as description, title, tags, and annotations.

In a further example, a user device 200 may delete a post, content, or derivative of same using interface. A user device 200 may engage with a “remove post” dialog box to delete or remove the storage of a post, content, or derivative work of same in one or more databases 420 (and links between content) or remove a representation associated with platform 100 of a post, content, or derivative work.

In a further example, platform 100 may compare two or more posts, content, or derivative works to generate links between the data structures storing the post contents. The comparison procedure applied to two or more posts can also identify and highlight the differences or similarities of the selected posts using various image comparison techniques. The result of the comparison may assist in developing new derivative works. Platform 100 may use image processing techniques to identify common elements in two images (e.g. content or derivative works) to generate links. User device 200 may select or otherwise indicate two or more posts, content, or derivative works of same, for example, by checking a box or selecting a checkmark beside each of the two or more posts, content, or derivative works of same. Platform 100 may then present user device 200 with the selected or otherwise indicated two or more posts, content, or derivative works of same. The presentation may allow and enable the user device 200 to visually compare the two or more posts, content, or derivative works of same, for example, by viewing them side by side or by viewing criteria associated with each, for example, pixel or histogram values.

In a further example, a user device 200 may register with platform 100 or an associated service by providing registration information, for example, e-mail, password, and username or by authenticating using a social media account, for example. The social media account information may be used by social network platform 102 to access data relating to social connections and social network content, for example.

In another example, a user device 200 may login to platform 100, for example, to be able to add a post, content, or derivative work. For example, a user device 200 may login by providing data, for example, an e-mail and password combination or a social media account, for example, Facebook. A user device 200 may engage with a “login” dialog box, which may solicit login credentials from the user device 200. A user device 200 may login only by providing data related to a user registration with platform or an associated service.

In a further example, a user device 200 may modify or add profile information. For example, a user device 200 may engage with a “profile” dialog box to modify their username, e-mail, password, profile photo, privacy, licenses granted over posts or content, and identity attributes.

In a further example a user device 200 may view a list of available plugins associated with platform 100 and apply a plugin to one or more selected posts simultaneously or individually. For example, a user device 200 or developer may associate one or more plugins with platform 100 by engaging with platform 100, selecting a button to associate a plugin with platform 100, and may transmit or cause to be transmitted data comprising an application including the plugin. A user device 200 may engage with platform 100, select a button to view one or more or all plugins associated with platform 100, and may select one or more said plugins to associated with the user device's 200 account used to access platform 100. Platform 100 may permit the user device 200 to access platform 100 to download data relating to the one or more said selected plugins. The user device 200 may subsequently engage with the one or more said selected plugins without subsequently indicating to platform 100 a desire to associate the one or more selected plugins with the user device's 200 account. The user device's 200 account may also be an account associated with a user of the user device 200. The user may use different user devices 200 to access platform 100.

In a further example, a user device 200 may share or edit particular posts; content; derivative works of same. User device 200 may also display or share one or more graphs; one or more sub-graphs or one or more portions of one or more graphs; one or more sets of posts or graphs based on graphical data structures generated by graph unit 108 using links between content and derivative works. User device 200 may share one or more posts, content, derivative works of same stored in one or more graph data structures or represented in one or more graphs with people engaged with the user's social media accounts, for example. Social network platform 102 can also generate a social network between users (e.g. user devices 200) of platform 100. This may provide social integration and may be an avenue of integration of platform 100 with social media. For example, a user device 200 may engage with a post, indicate a desire to share the post by selecting a “share” button, and select one or more other users or user devices 200 with which to share the post. The share feature can allow the user of the platform 100 to share a particular post or graph or subgraph to their other social media platforms 102 or sites.

In another example, a user device 200 may use platform 100 to search for one or more particular posts; content; derivative works of same; one or more graphs; one or more sub-graphs or one or more portions of one or more graphs; one or more sets of posts or graphs; and one or more posts, content, derivative works of same stored in one or more graph data structures or represented in one or more graphs. The user device 200 may perform the search using a title, description, one or more tags, username associated with the subject, or other data associated with the search item or items. For example, the user device 200 may engage with platform 100, select a “search” button, and input data in an input field indicating criteria associated with the item to be searched. In some embodiments, as the user is inputting data, the user may be presented with one or more suggested data inputs, for example, in a drop-down list or in the input field.

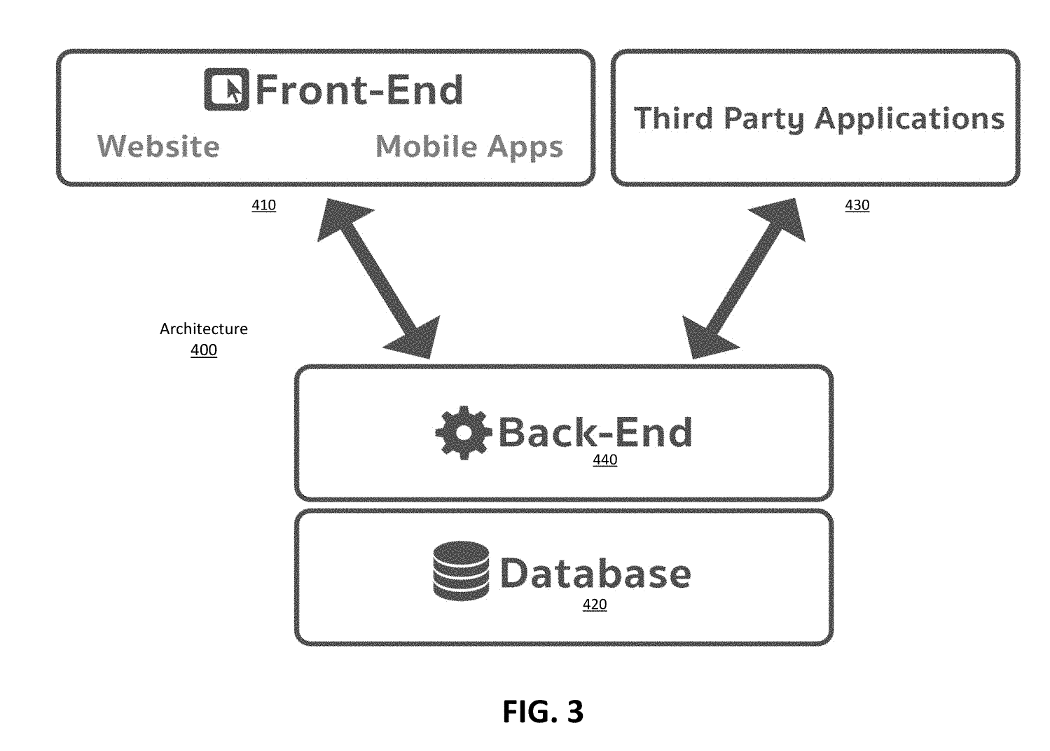

FIG. 3 is a schematic diagram showing example architecture 400 of platform 100 according to some embodiments. Architecture 400 includes a database 420 (on a persistent data storage device), backend components 440, front end components, and third-party applications 430.

Back-end components 440 can be responsible for providing a RESTful web API to the front end components 410 and third party applications 430. Back-end components 440 provide the following incomplete list of functionality: add/remove/edit user posts as posts can be of type image, videos or text; manage user profiles; perform comparison among posts or trees.

Front-end components 410 can be responsible for calling the web service, obtaining the content from the back end components 440, and presenting them to the user. The posts are presented to the user in form of graph structure visual representation as part of a user interface. This component is comprised of the web version accessible by a browser, as well as the mobile application for mobile devices.

Through the front-end components 410, users of platform have the ability to: Navigate the trees, zoom in and zoom out; Search for posts by name, user, tags and description; Add or remove posts; Add, remove or edit the details of their posts; Share a post through their social media; Edit their user profile information.

Database 420 provides functionality for managing and processing the posts as well as user profile details. Contents shared by users are stored in a graph database. User profiles are stored in a relational or a document database 420. Data mining processes can be applied on the content to produce useful patterns and actionable insights. The online platform 100 can provide an improved user experience. The platform offers a mobile and desktop version. Good user experience can involve a modern and clutter free design with easy and intuitive search and navigation capabilities. User can have the ability to edit, tag and annotate posts with ease. Users can have the ability to ability to zoom in, zoom out and view posts as slideshow. Users can have the ability to drag and drop new posts to a tree. Users can have the ability to edit posts on the browser or mobile app without the need to download the posts. However download and upload feature can be available.

The online platform 100 can provide scalability and performance. The platform 100 can have the ability to scale when needed and provide uninterrupted and high performance service to number of users. The online platform 100 can provide security and privacy for users and their content. The platform can offer privacy on users' profiles. The platform can offer privacy and copyright options for users' posts. The platform can provide proper security measures to protect user's accounts.

Third Party Applications 430 can provide developers with the ability to develop custom apps. These apps can use a subset of a platform API to gain access to users' posts and profile and be integrated into users' accounts. (provided the users have given the consent). The purpose of such apps is to offers users more advanced functionalities and features. The following are example apps: Advanced image comparisons and morphing techniques; Face detection; Online editor for file formats not natively supported by the framework; Bulk uploader; photo editing plugin to allow seamless import to the online platform 100 directly from a photo editing environment; Advanced visualization of posts and exporting features.

While many languages can be used to develop the back-end component, an example for the back-end component is Java EE along with Spring Framework. Java and Spring together provide a rich set of features to develop large-scale enterprise level web applications.

The Front-end component can be developed using HTML5, CSS3, jQuery and a Javascript framework such as AngularJS or React, as an example. In addition web based data visualization libraries based on SVG, Canvas or CSS3 such as Raphael and D3 may be used. These libraries help to create aesthetically pleasing web interfaces and improve the user experience. The database component 420 can contain the user profiles and user posts. Given the way that user posts are connected to each other, a graph database engine such as OrientDB or Neo4J will be used to store the posts. Furthermore to store user profiles, a relational or document-oriented database such MySQL or OrientDB is used. Note that OrientDB provides both graph and document-oriented database. The technologies used for data mining features.

The user device 200 may request a search by providing input data to components of the architecture 400 of platform 100. The search request triggers front-end component 410 to interact with back-end component 440 and back-end component 440 to interact with database component 420 to request and receive data associated with the requested item(s) of the search request. Database component 420 may locate and receive the requested item(s) or data relating to same from one or more data storage devices. The location and receipt of the requested items(s) or data relating to same may be efficient as the one or more databases 420 may be graph databases or one or more databases using one or more graph storage structures. Platform 100 may present user device 200 with the search results of item or items in a perspective that may be easily browsable and filterable.

In a further example, a user device 200 may browse one or more posts; content; derivative works of same; one or more graphs; one or more sub-graphs or one or more portions of one or more graphs; one or more sets of posts or graphs; and one or more posts, content, derivative works of same stored in one or more graph data structures or represented in one or more graphs. A front-end component 410 may provide a simple yet customizable way of listing same. A front-end component 410 may be configured to enable a user device 200 to browse same using the least number of mouse gestures or clicks and without being confused on how to navigate and select an item. For example, a user device 200 may scroll through all available (and viewable to the user device 200 according to privacy settings associated with each) posts, content, derivative works of same, or graphs, for example, that are presented in a graph perspective 700 with the mouse, keyboard, or haptic engagement and be presented by platform 100 with a title, description, tags and other details of the posts, content, derivative works of same, or graphs with ease. Platform 100 may selectively present data associated with each post, content, derivative of same, or graph, for example, not every detail of same may be visible or presented to the browsing user device 200. Less common details may be only visible by particular engagements with platform 100 by user device 200, for example, when user device 200 engages with platform by directing an indicator to hover over the item or when user device 200 selects the item by clicking on the item or pressing on the location of the representation of the item on the device that user device 200 uses to engage with platform 100. Front-end component 410 may be configured to present an interface allowing engagement with platform 100 that is as clutter-free as possible so as to bring more attention to the content and especially the presence, absence, or nature of relationships between and amongst posts, content, or derivative works of same. The relationships may be visibly displayed using graph structures generated by graph unit 108.

Front end component 410 includes web and mobile application components. In some embodiments, platform 100 or front-end component 410 may include a home page or suggestions page. For example, platform 100 or front-end component 410 may provide one or more suggestions to a user device 200 engaged with platform 100 or front-end component 410. The one or more suggestions may be of one or more posts; content; derivative works of same; one or more graphs; one or more sub-graphs or one or more portions of one or more graphs; one or more sets of posts or graphs; and one or more posts, content, derivative works of same stored in one or more graph data structures or represented in one or more graphs generated by graph unit 108 based on links. For example, platform 100 may identify the one or more suggestions using content management unit 106 tools included in back-end component 440. The content management unit 106 tools may engage with content stored in one or more databases 420, identify trends relating to data associated with or comprising said content, process said content, combine data relating to the content, and identify suggestions, for example, by identifying popular content based on the number of times content has been viewed by users 200, based on the number of votes or preference selections have been associated with content, based on the number of revisions created of or derivative works created from content, or the number of contributors to content. A home page or suggestions page may be configured by the user device 200 by selecting or customizing settings or auto-configured by platform 100 based on the user device 200 preference and activities while engaged with platform 100.

In some embodiments, platform 100 may include social media platform 102 for integration, for example, with existing social media sites. For example, a user device 200 may register with or login to platform 100 using a user's existing social network account or data relating to same. A user device 200 may share posts, content, or derivative works of same associated with, stored in, or presented by platform 100 with other social media sites. In a further example, an application integrated with or used on a social media sites may provide integration with platform 100. For example, an application on or associated with a social network may be used to display or present content of a graph within a social network post, without the need to open the post or content on platform 100 or engage with the post or content through platform 100 or a website interface of the platform 100.

In some embodiments, the platform 100 may include or be associated with content management unit 106 having one or more online editing tools, online editors, or online canvases. An online editing tool, online editor, or online canvas included in or associated with platform 100 may allow user devices 200 to make revisions to existing posts or content, modify existing posts or content, create new derivative works, or associate data such as comments, tags, or metadata with existing posts or content without downloading or saving a copy of any posts or content locally. This may eliminate any need to use a third-party service or a locally installed application to create or modify a work. However, in some embodiments, user device 200 can have a locally installed application for data exchange with platform 100. The locally installed application may include content management unit 106 or components and content tools of the content management unit 106. The posts, content, or derivative works may be images, videos, text, or other media. An online editing tool, online editor, or online canvas included in or associated with content management unit 106 of platform 100 may enable a user device 200 to import or export works or content with ease. The online tool, online editor, and online canvas may support popular file formats, for example, JPEG, GIF, PNG, BMP, CAD, and PDF. The online tool, online editor, and online canvas may support image and video formats and text content.

In some embodiments, an online platform 100 may be associated with a tracking component that may enable the capture of information relating to user device 200 interactions 300 with online platform 100, for example, the identity of a user device 200 that created a specific derivative content and timestamp data for the creation of the derivative work. The timestamp data may be used by graph unit 108 when generating graph structures to add a time dimension to the nodes and edges.

In some embodiments, the content management unit 106 may be associated with a revision management component that may assist with providing version control and the ability for a multiplicity of user devices 200 to amend, create, delete, or collaborate on the same or related posts or content. This revision management component may identify links between content and derivative works and resolve conflicts for simultaneous modifications to the same content by different user devices 200.

Referring back to FIG. 3, front-end component 410 may be responsible for calling a web service; requesting or receiving data, posts, content, or derivative works of same from back-end component 440; or engaging one or more user devices 200 with the platform 100. For example, user devices 200 may view data, posts, content, or derivative works of same in the form of a graph structure, slideshow, linear representation, or one or more combinations of same. User devices 200 may amend posts, content, or derivative works of same; engage with an online editor associated with platform 100; manage their own user profile or account settings; manage, amend, view, engage with, or interact with other users' posts, content, or derivative works of same, for example, comment or tag a post created by another user; or engage with one or more other users 200. Front-end component 410 may include a web version accessible by an internet browser and a mobile application accessible by and compliant with iPhone and Android compliant devices.

In some embodiments, front-end component 410 may enable one or more users to engage with platform 100 by navigating interfaces with viewable representations of content, posts, or derivative works of same, for example, navigating tree or graph structures by zooming in and zooming out of nodes of the tree or graph structure; searching for one or more posts, content, or derivative of same by providing one or more attributes, for example, name, user, creator, associated tag, and associated description; adding or removing content, posts, or derivative works of same; adding, removing, editing associated data, for example, detail, tags, comments, or descriptions, of content, posts, or derivative works of same that are created by the user device 200; sharing a post, content, or derivative of same through one or more social media platforms or through platform 100; and editing profile information, settings, and account settings associated with the user device 200. The nodes of the graph or tree structure correspond to content or derivative works and a visual representation of the nodes may include a visual representation of the corresponding content or derivative works. User device 200 can interact with nodes to enlarge the visual representation of content and trigger content management unit 106 to enable creation of additional derivative works for content shown in the visual representation of the graph structure.

In some embodiments, an interface of platform 100 may be presented to one or more user devices 200 as a single page web application interface. User devices 200 may view posts, content, or derivative works of same from one or more different perspective views and may switch to a different perspective view using view or content control commands. In each perspective of a post, content, or derivative of same, a user device 200 may view a description, one or more tags, a username, and other metadata related or associated with the post, content, or derivative of same. Further, a user device 200 may comment on, share, or create a derivative of the post or content.

In some embodiments, a web page application interface associated with platform 100 may solicit engagement from one or more user devices 200 by displaying a web dialog box or textual representation conveying one or more ways in which a user device 200 may engage with platform 100. For example, user device 200 may engage with platform to edit a post, add a post, compare posts, sign-in, register, edit a profile, or view plugins.

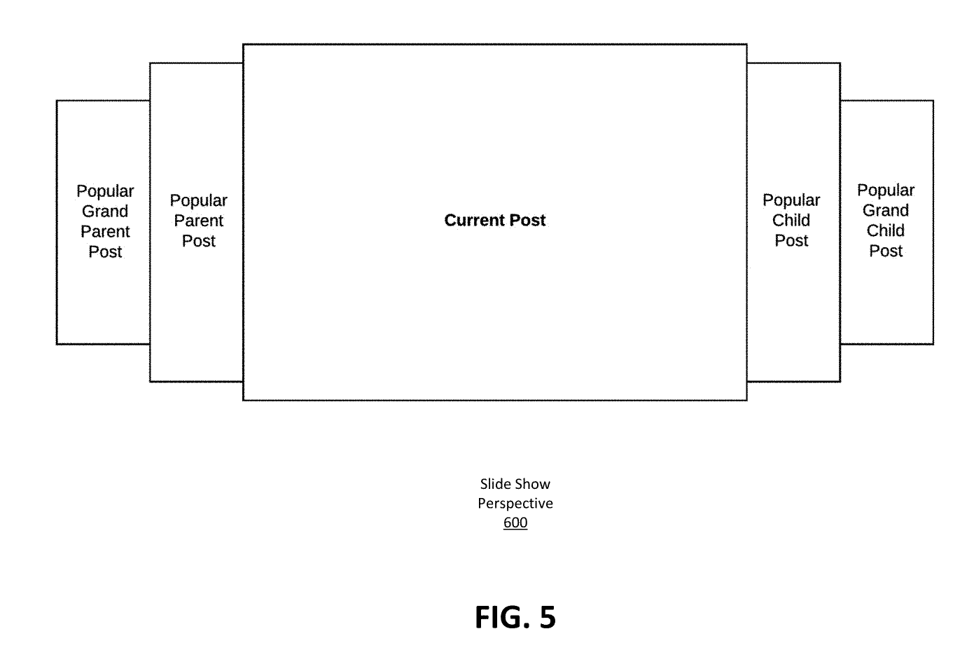

In some embodiments, one or more posts, content, or graph structures relating posts or content may be presented to a user device 200 in a slide show perspective 600, which is a visual representation of posts as part of an interface. FIG. 5 is a diagram of an example slide show perspective 600. For example, a user device 200 may switch to a next or a previous post by clicking on or selecting the next or previous post. A slide show perspective 600 may enable the presentation of nodes of a linear or non-linear graph structure relating posts or content. For example, to present posts or content whose relationships may be depicted by a non-linear graph (for example, when a post has more than one derivative work), navigating once or successively to the left on the slideshow perspective 600 may show the most popular parent or ascendant post and navigating once or successively to the right on the slideshow presentation may show the most popular child or descendant post. Post or content popularity may be defined by the post's or content's view count, rating, a combination of same, or a definition indicated by the user device 200. A slide show perspective 600 may include a navigation panel that may allow a user device 200 to navigate to less popular or other child, parent, ascendant, or descendant posts.

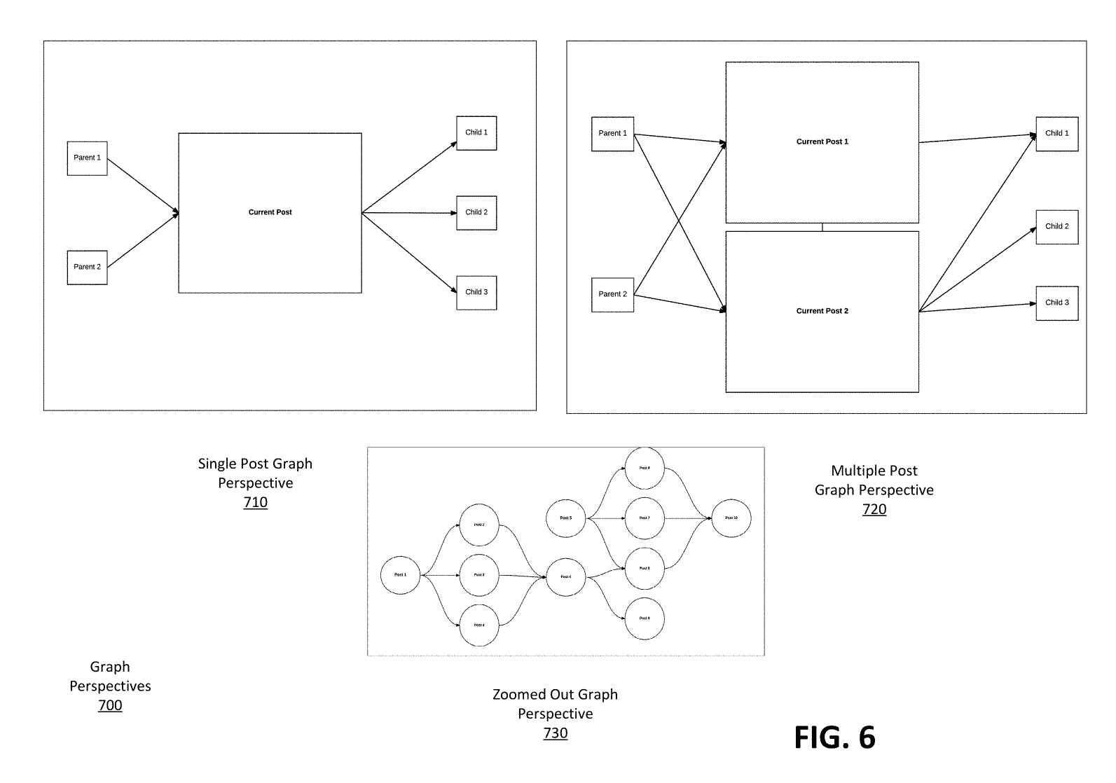

In some embodiments, one or more posts, content, or a graph structure relating posts or content may be presented to a user device 200 in a graph or tree structure perspective generated by graph unit 108 based on links between content and derivative works of that content. FIG. 6 is a diagram of example interface with graph perspectives 700, which are visual representations of nodes of graph structure generated by graph unit 108. Graph perspectives 700 can include single post graph perspective 710 and multiple post graph perspective 720. Single post graph perspective 710 may present a user device 200 with a single first post, first content, or first derivative work of same that is selected, in focus, or viewable by user device 200. The single post graph perspective 710 may also present a user device 200 with one or more other posts, content, or derivative works of same that are associated with the first post, first content, or first derivative of same. For example, the one or more other posts, content, or derivative works of same may be related to, an ascendant node of, or a descendant node of a node representing a first post, first content, or first derivative of same. The one or more other posts, content, or derivative works of same may not be in focus, selected, or viewable by user device 200. For example, they may be smaller or presented as thumbnail images. In some embodiments, a graph perspective 700 may present one or more or all associations that may exist between or amongst each node for a post, content, or derivative of same that is presented to a user device 200. For example, an arrow may be presented that extends from a parent node (representing a post) to a child node (representing a post).

A user device 200 may engage with an interface visually displaying graph perspective 700 by navigating the graph perspective 700 to view one or more posts, content, or derivative of same; zoom in or zoom out on a portion of or the entire graph perspective 700; and view multiple graphs simultaneously. A graph perspective 700 may be used by platform 100 to present linear or non-linear graph structures of nodes representing posts or content.

In some embodiments, one or more posts, content, or a graph structure relating posts or content may be presented as part of an interface on a user device 200 in a text-based perspective. For example, text data relating to one or more posts, content, or derivative works of same, such as title, time stamp, description, and username, may be displayed to a user device 200 in a hierarchical, tree-like structure. In a further example, text data may be presented to a user device 200 as a linear text based history, for example, as in a revision history of a wiki page.

In some embodiments, one or more posts, content, or a graph structure relating posts or content may be presented to a user device 200 in a full screen perspective. For example, a user device 200 may select a “full screen” button associated with platform 100 to view a post, content, or derivative work of same that is currently selected, focused on, or engaging user device 200. The post, content, or derivative of same may then be displayed as a “full screen”, for example, completely fill a display used by user device 200 to engage with platform 100. A user device 200 may exit a full screen perspective by selecting the same button associated with platform 100 or pressing an escape key associated with a device that may be used by user device 200 to engage with platform 100.

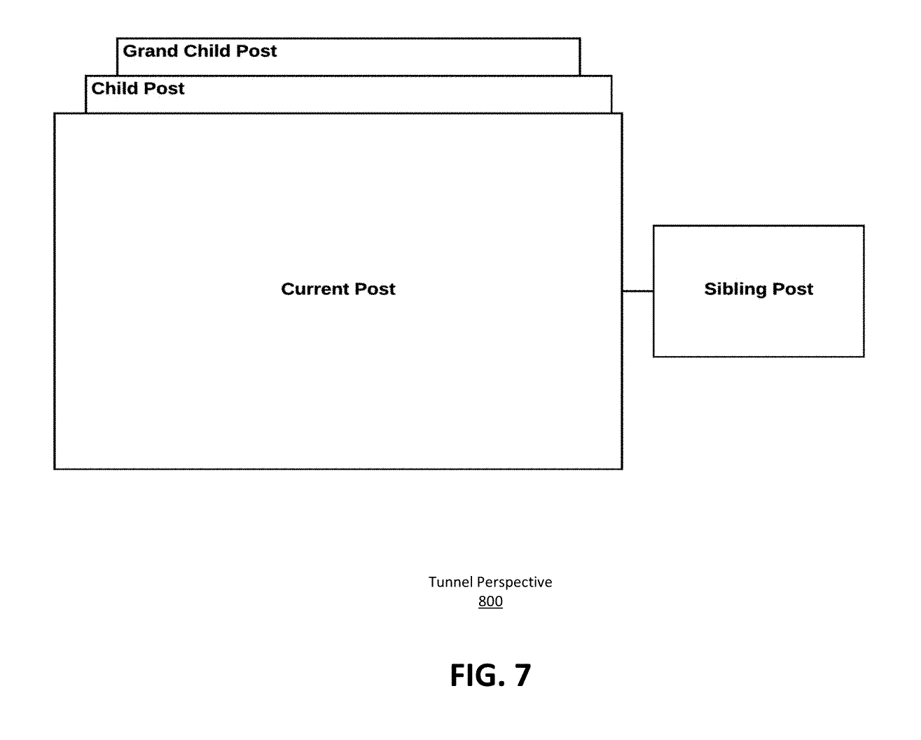

In some embodiments, one or more posts, content, or a graph structure relating posts or content may be presented to a user device 200 in a tunnel perspective. FIG. 7 is a diagram of an example interface with a tunnel perspective 800. For example, a tunnel perspective 800 may present a user device 200 with one or more posts, content, or graph structure relating posts or content as a sequence of posts or content ordered along the Z coordinate. This may resemble or be similar to a slideshow where subsequent posts or content appear behind, for example, completely or mostly covered by, a first post or first content. A first post or first content may be “full screen”, for example, completely fill a display used by user device 200 to engage with platform 100. A user device 200 may navigate to a child node, parent node, ascendant node, or descendant node representing posts or content of a first post or first content that is currently selected, focused on, filling a display used by user device 200 to engage with platform 100, or engaging user device 200. For example, a user device 200 may navigate through or view a subsequent node, previous node, child node, parent node, ascendant node, or descendant node representing post or content by moving a curser up or down or by pressing arrow keys associated with the user device 200 to engage with platform 100.

In some embodiments, one or more posts, content, or graph structures of nodes relating posts or content may be presented to a user device 200 in one or more perspectives enabled, created, or facilitated by one or more plugins associated with platform 100 or third-party applications 430. A plugin may use one or more application programming interfaces (APIs) configured to allow access to components of platform 100 or artificial intelligence processes.

Front-end component 410 may be developed using one or more languages, for example, all of HTML5, CSS3, jQuery, and a Javascript framework such as AngularJS. Implementation of front-end component 410 may use web-based data visualization libraries based on SVG, Canvas, or CSS3, for example, Raphael and D3, to help create aesthetically pleasing web interfaces and improve user device 200 experience with platform 100.

One or more databases 420 may enable management and processing of posts, content, or derivative works of same; data associated with posts, content, or derivative works of same; and user profiles, profile information, settings, account settings, and data relating to use of platform 100 that may be associated with user devices 200. For example, posts, content, or derivative works of same may be stored in one or more graph databases by platform 100. Platform 100 may use one or more relational or document databases 420 to store profile information, settings, account settings, and data relating to use of platform 100 that may be associated with users 200. In some embodiments, data mining processes may access or engage one or more databases 420 associated with platform 100 to analyze data, content, posts, derivative works of content or posts, engagement with platform 100 by users 200 in order to produce useful patterns, actionable insights, or trends relating to same or combinations of same.

One or more databases 100 may be implemented using a graph database engine, for example, OrientDB or Neo4J to enable platform 100 to store posts, content, derivative works of same, or associations between or amongst same. The one or more databases 100 may store all data relating to one or more graphs to enable platform 100 to support a multiplicity of graph structures. A single graph structure may include nodes for all posts, content, and derivative works of same that are related to each other, for example, all parent nodes, child nodes, ascendant nodes, and descendant nodes of a post and all parent nodes, child nodes, ascendant nodes, and descendant nodes of same. One or more databases 100 may be one or more relational or document-oriented databases, for example, MySQL or OrientDB, and may be used by platform 100 to store user device 200 profiles or data relating to user device 200, user device 200 profiles, and user device 200 accounts.

Platform 100 may be associated with, engage with, or support one or more third-party applications 430. A third-party application 430 may use one or more APIs configured to allow access to components of platform 100. The one or more APIs may allow a third-party application 430 to engage with or gain access to posts, content, or derivative works of same associated with a user device 200 or platform 100.

Third-party applications 430 may engage with platform 100 using one or more RESTful APIs configured to allow access to components of platform 100. Third-party applications 430 may extend the functionality of or provide extra features to platform 100, which may result in a better user experience for a user device 200 engaging with platform 100. A third-party application 430 may be a plugin to platform 100 or be a separate stand-alone service. Plugins provide extra features from within the platform 100.

For example, a user device 200 may download and install a third-party application on the user device 200 and the third-party application 430 may access data related to the user device 200, including, for example, content, posts, or derivative works of same created by the user device 200. Third-party applications 430 or one or more APIs configured to allow access to components of platform 100 may enable one or more user devices 200 further functionality or features in relation to the one or more user devices' 200 engagement with platform 100. For example, third-party applications 430 may support or enable, in relation to platform 100, advanced image comparisons, morphing techniques, and online image manipulation tools; face detection; an online editor for certain file formats; bulk uploading of content, posts, derivative works of same, or other data; an image editing plugin to allow seamless import to platform 100; advanced visualization of posts, content, or derivative works of same; enhanced exporting features; creation of a scrapbook including posts, content, or derivative works of same selected by a user device 200; or creation of an interactive mosaic including one or more or all posts, content, or derivative works of same associated with a platform 100.

For example, a third-party application 430 may enable advanced image comparisons. Platform 100 may provide multiple methods of comparing two more posts or two or more graphs without requiring engagement with a third-party application 430. A third-party application 430 may assist in providing more complex comparison solutions or comparison techniques specific to a certain industry or field.

For example, a third-party application 430 may enable morphing techniques, image analysis, and image transformation techniques. Plugins may apply image-processing techniques to posts, content, or derivative works of same to analyze and produce new derivations. For example, a plugin may apply a two-dimensional spatial transformation on a post composed of a rectangle object to produce a post composed of an square object.

For example, a third-party application 430 may enable face detection. A plugin may be associated with platform 100 that detects faces in content and may group similar faces into a single graph. For example, a third-party application 430 may enable additional features to or extend file formats that may be supported by an online editing tool associated with platform 100. A third-party application 430 may enable bulk uploading. A plugin may be associated with platform 100 to allow upload of multiple new posts, content, or derivative works of same.

A third-party application 430 may enable advanced visualization techniques or additional perspectives for a user device 200 to engage with one or more posts, content, derivative works of same, graphs, portions of one or more graphs, posts or content stored in one or more graph data structures, or posts or content represented by one or more graphs. For example, a third-party application 430 may enable the following perspectives with which a user device 200 may engage with one or more posts, content, or derivative works of same: generation of a navigable mosaic from a selection of posts, automatic re-organization of posts based on certain criteria such as popularity, creation of new graphs by pruning and reorganizing existing graphs, automatic generation of a single blended overlay post from multiple posts, automatic generation of a video from multiple posts, automatic generation of new posts based on existing posts through the use of machine learning and pattern recognition techniques, or image prediction. Algorithms enabling image prediction may produce interesting results that may be used to predict the future or estimate the past of existing trends, designs, or processes.

Back-end component 440 may support functionality of platform 100, for example, by providing an ability to add, remove, edit, retrieve, search, navigate, comment on, tag, or associate data with one or more posts, content, or derivative work of same. Back-end component 440 may support different types of posts or content such as images, videos, text, or one or more combinations of same. Back-end component 440 may support management, updating, editing, deleting, or modification of user device 200 profiles or account settings. Back-end component 440 may support user device 200 to compare one or more posts, content, or derivative of same, one or more entire graph structures, one or more portions of one or more graph structures, or one or more portions of one or more posts, content, or derivative of same. Back-end component 440 may be responsible for providing a RESTful web API to the front-end component 410 or one or more third-party applications 430 and may provide REST-compliant web services. Back-end component 440 may be implemented using one or more languages, for example, Java EE in combination with Spring Framework, to provide a rich set of features to support a large-scale enterprise level web application 100.

Back-end component 440 may include one or more modules, for example, a web service module, security modules, image processing tools, or core tools. A web service module may be an API service for authenticated applications, for example, a front-end component 410. The API service may offer operations that enable or assist functionality associated with platform 100, for example, login of a user device 200; logout of a user device 200; register a user device 200; get a post, content, or derivative; create a post, content, or derivative; create a user or data associated with a user device 200; delete a post, content, or derivative; delete a user or data associated with a user device 200; edit a post, content, or derivative; edit a user or data associated with a user device 200; search post, content, derivative of same, user, tag, comment, description, annotation, relationship, or data associated with platform 100; browse post, content, derivative of same, user, tag, comment, description, annotation, relationship, or data associated with platform 100; view one or more plugins; or apply, use, or engage one or more plugins. A security module may be responsible for, enable, facilitate, or be used for authentication, authorization, or access control, for example, control of ability to engage with platform 100, front-end 410, databases 520, third-party applications 430, back-end 440, architecture 400, or component of platform 100.

Image processing tools may transform content to generate derivative works by performing image processing operations, for example, comparison, compression, modification, merging, combining, or prediction of images, videos, text, posts, content, derivative works, or representations of same. Core tools may include tools enabling configuration, session management, logging, parsing, processing, and reporting functionality. Front-end component 410 may send data to, receive data from, or interact with back-end component 440.

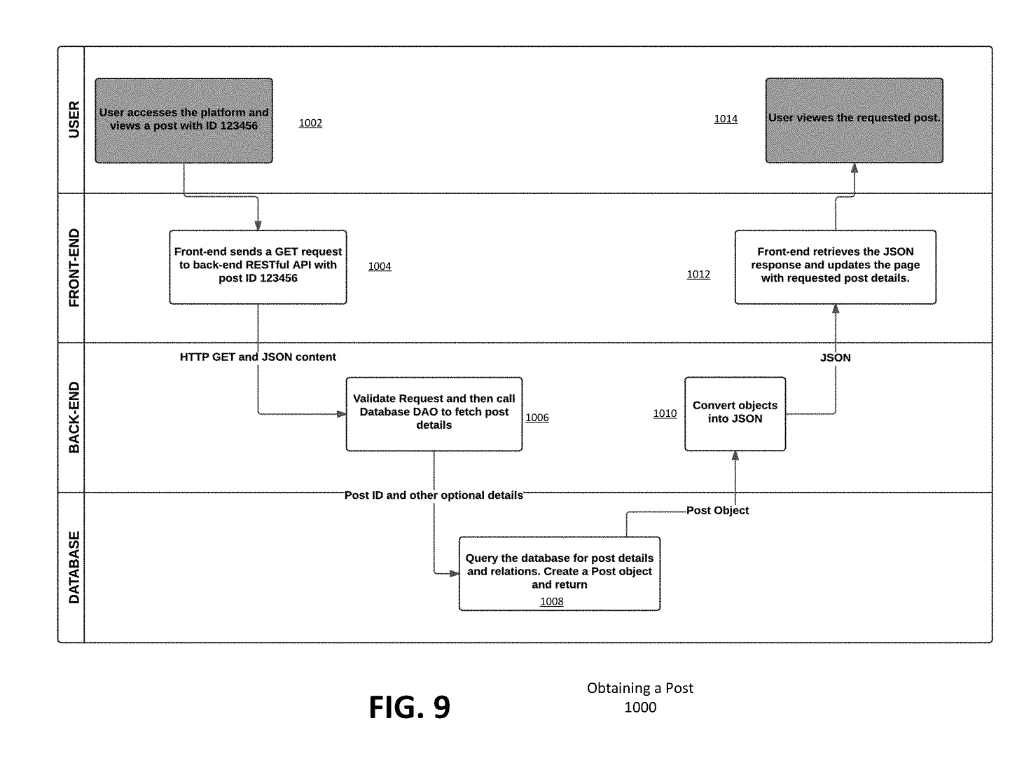

FIG. 9 is a diagram of an example process 1000 for obtaining a post.

At 1002, a user device 200 engaged with platform 100 through front-end component 410 requests a particular post, for example, by navigating to the post through engaging with platform 100 in a graph perspective 730.

At 1004, front-end component 410 calls an operation to “get” or retrieve data relating to the post by sending an HTTP GET request to a back-end component's 440 API end-point and receive POST_ID, identification data associated with the requested post.

At 1006, back-end component 440 validates the request from front-end component 410. In some embodiments, validation may include authentication of the user device 200 and associated client, determining that the client and the user device 200 are authorized to access, engage with, or view the post, and determining that the request, parameters, and associated data are valid. For example, back-end component 440 authenticates, for example, a third-party application 430 or user device 200 to engage with platform 100, or application associated with or engaged with platform 100. Platform 100 authenticates the user device 200, for example, if the user device 200 is logged into platform 100, who requested the post. Back-end component 440 determines whether the requesting client and user device 200 are authorized to access, engage with, or view the post. For example, if the client or user device 200 is not authorized to access, engage with, or view the post, for example, the post is associated with privacy data indicating the user device 200 may not view the post, then back-end component 440 may return an error message to front-end component 410 or the user device 200 may be presented with an error message. Back-end component 440 determines whether the request, parameters, and associated data are valid, for example, whether a POST_ID identification data associated with the requested post and included in the request is valid or null. For example, if the POST_ID identification data is not valid or does not relate to or correspond to a post stored in a database 420 associated with platform 100 then back-end component 440 may return an error message to front-end component 410 or the user device 200 may be presented with an error message.

At 1008, if the request from front-end is validated, back-end component 440 communicates with the database component 420 or one or more databases 420 by calling a specific internal Java API method with one or more parameters, including the POST_ID identification data. Back-end component 440 or database component 420 may search or cause to be searched one or more databases 420 for the post identified by the POST_ID identification data. Database component 420 receives data comprising or relating to the post from one or more databases 420, processes the data, combines the data, or constructs the post from the data, and returns the data, processed data, or constructed data to back-end component 440, for example, as a Java object representing the requested post.

At 1010, back-end component 440 processes, packages, and refines the Java object returned by the database component 420 into a JSON object and returns the JSON object to the front-end component 410.

At 1012, front-end component 410 processes the JSON object and presents the requested post, requested content, or data relating to same to the user device 200.

At 1014, user device 200 may view or engage with the requested post, requested content, or data relating to same.

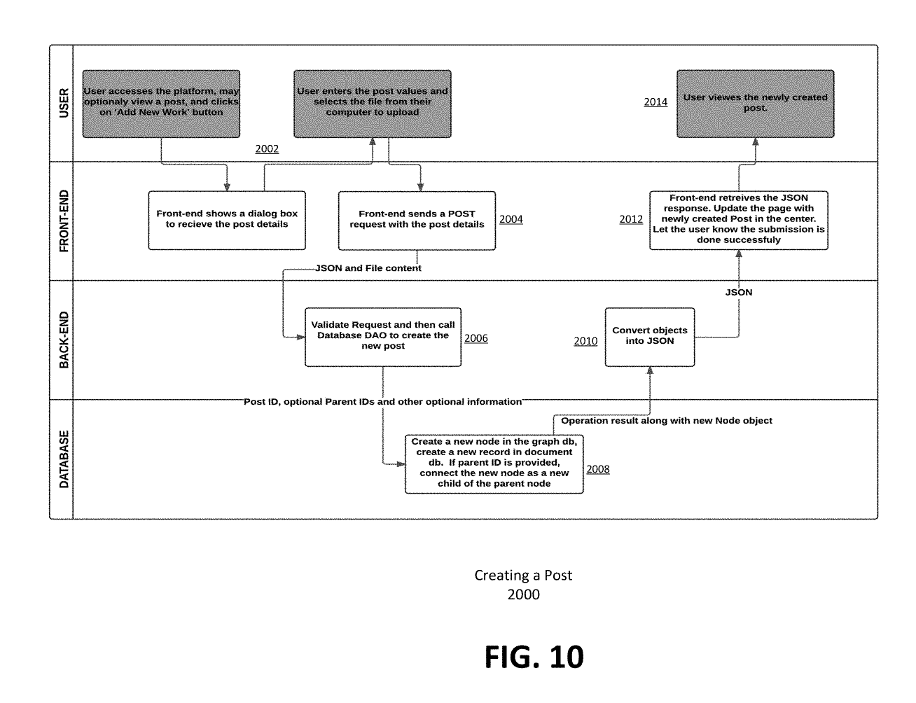

FIG. 10 is a diagram of an example process 2000 for creating a post or content.

At 2002, user device 200 engages with platform 100 to create a new post, for example, by selecting an “add” button. This operation is generally initiated by the front-end to create a new post. The user device 200 may provide additional data to be associated with the post, for example, a post title, post description, and privacy settings.

At 2004, front-end component 410 sends an HTTP POST request to a back-end component's 440 API end-point, creates, or passes a JSON object, including, for example, identification data for one or more parent posts to be associated with the newly created post, along with the request.

At 2006, back-end component 440 validates the request from front-end component 410. In some embodiments, validation may include authentication of the user device 200 and associated client, determining that the client and the user device 200 are authorized to create the post, and determining that the request, parameters, and associated data, for example, post title, post description, privacy settings, and file format are valid. For example, back-end component 440 authenticates the client, for example, a third-party application 430, device used by the user device 200 to engage with platform 100, or application associated with or engaged with platform 100 and authenticates the user device 200, for example, if the user device 200 is logged into platform 100, who requested the post. Back-end component 440 determines whether the requesting client and user device 200 are authorized to create the post. For example, if the client or user device 200 is not authorized to create the post then back-end component 440 may return an error message to front-end component 410 or the user device 200 may be presented with an error message. Back-end component 440 determines whether the request, parameters, and associated data are valid. For example, if the post title is not valid, for example, is null or empty, then back-end component 440 may return an error message to front-end component 410 or the user device 200 may be presented with the error message.

At 2008, if the request from front-end component 410 is validated, back-end component 440 communicates with the database component 420 or one or more databases 420 by calling a specific internal Java API method with one or more parameters, including the data or the JSON object. Database component 420 stores the data, the JSON object, or data relating to the request to create a new post, for example, indicating relationship to one or more other posts, and returns the POST_ID or other data associated with the newly created post.

At 2010, the back-end component 440 packages the details of the newly created post in a JSON object and returns the JSON object or data associated with the newly created post to the front-end component 410.

At 2012, front-end component 410 receives or processes the JSON object and presents the new post, new content, or data relating to same to the user device 200.

At 2014, user device 200 may view or engage with the created post, created content, or data relating to same.

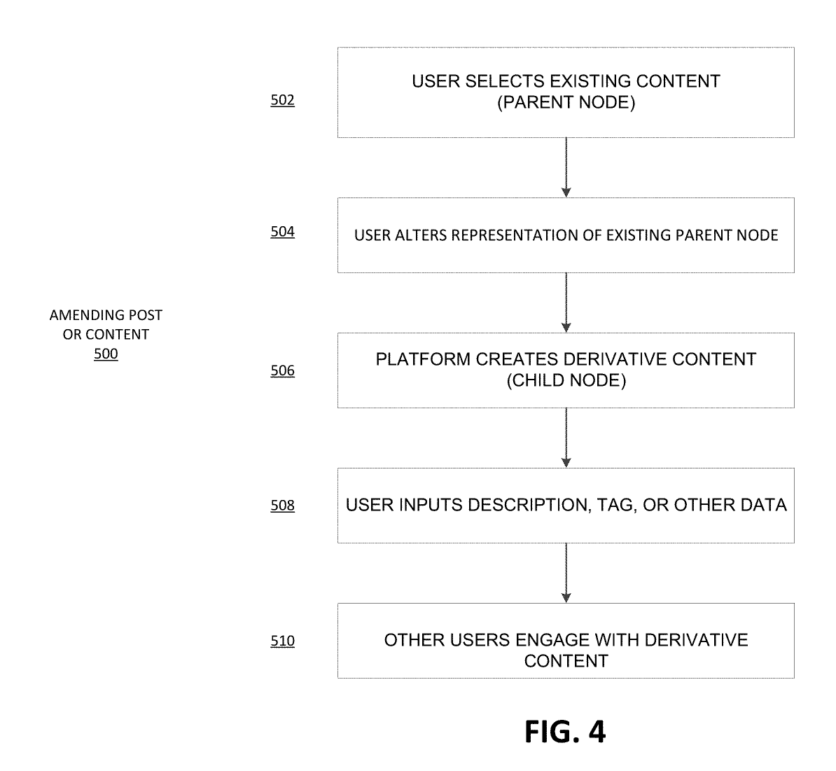

FIG. 4 is a diagram of an example process 500 for amending or modifying a post or content.

For example, at 502, a user device 200 may select one or more first posts or first content presented by platform 100. The selected one or more first posts or first content may be referred to as a parent post or parent content.

At 504, the user device 200 may alter or modify the parent post or parent content, or cause data, such as, meta data, comments, or tags, to be associated with the parent post or parent content. The altering, modification, or association may be enabled by an online editor associated with the online social collaboration platform 100 so that downloading or saving a copy of any posts or content locally does not have to occur. For example, an online editor may present the user device 200 with blank canvas or a canvas showing the one or more parent posts or parent content. A user device 200 may request or toggle between either. A user may instead upload a second post or second content, for example, by selecting an “Add New” button. The content or post uploaded or created at 504 may be referred to as a derivative post or derivative content. In some embodiments, an online editor associated with platform 100 may be used to automatically merge one or more selected parent posts or parent content.

At 506, online social collaboration platform 100 creates a new derivative content or post and saves, transmits, or displays information relating to one or more associations between the new derivative and one or more other posts or content. The content management unit 106 creates and stores a link between the content and the derivative work in database 124. The graph unit 108 generates a graph structure using the stored links to graphically depict the content and derivative work as nodes with edges for the links.

At 508, the user device 200 may cause data, for example, meta-data, comments, or tags to be associated with the new derivative. For example, the user device 200 may associate the derivative with information relating to privacy. This may enable the user device 200 to ensure the derivative is only viewable by certain other users or viewable only by the user device 200.

At 510, one or more users 200 may interact with the derivative work. This may include generating additional derivative works from the derivative work, sharing the derivative work or other interaction. A single post may be derived from one or more existing posts. This process 500 may be repeated one or more times and may allow derivative works to be created indefinitely.

Social collaboration platform 100 may allow a multiplicity of posts or content to be associated with a multiplicity of other posts or content and the multiplicity of associations may be presented to a multiplicity of users 200. The associations may be links between content which are represented in a graph structure as nodes and edges.

Presenting information related to one or more associations between or amongst one or more posts or content may enable users 200 to understand and exploit information related to how one or more posts or content may have been generated or amended. Collaboration platform 100 may be differentiated from other social media platforms and online creative work repositories by using graphical representations (e.g. graph data structures of nodes and edges) for relationships between and amongst content, posts, or derivative works of same provided by user devices 200. The nodes may be associated with content and the user device 200 that created the content. The nodes may also have a time-based dimension based on timestamps obtained when the content was created or uploaded to platform 100. This emphasis enables depiction of the relationships in the form of graph structures that are navigable, searchable, and extendable. The graph structures are used to generate different visual representations or perspectives of the content in an interface displayed on user device 200.

Platform 100 may be a social media site with a broad target market including designers, architects, engineers, scientists, scholars and researchers and any user device 200 who is interested in viewing or contributing to an idea in an open and collaborative system.

Platform 100 may provide a collaborative revision management platform where revisions, posts, content, or derivative works of same may be stored in a graph data structure. This model allows for one or more revisions or derivative works based on one or more original designs. In contrast to existing social media sites where every post or image may be independent of another or in groups or associated by tags, platform 100 may place emphasis on revisions or derivative works of a post or content as well as the relationships amongst or between them.

Platform 100 may be a collaborative platform with easy to use and intuitive navigation, editing tools, and plugins to perform various image processing operations on posts, content, derivative works, sub-graphs, portions of one or more graphs, one or more entire graphs, content represented in one or more perspectives, content stored in one or more portions of one or more graphs, or content stored in one or more entire graphs. Such operations may include image comparison, image overlay, and image analysis.

Platform 100 may enable, facilitate, or generate insights or new posts, content, or derivative works of same based on existing posts, content, derivative works, sub-graphs, portions of one or more graphs, one or more entire graphs, content represented in one or more perspectives, content stored in one or more portions of one or more graphs, or content stored in one or more entire graphs by using machine learning, pattern recognition, image processing techniques, or image prediction. Generation of new posts using artificial intelligence may produce interesting results that may be used to predict, construct, or present future or past versions of existing trends, designs, and processes. Platform 100 may automatically create derivative works using artificial intelligence techniques. Platform 100 may trigger a new set of research opportunities on graphs, content or relationships that may be stored in or represented by one or more graphs or graph data structures, and collaborative platforms.

Online social collaboration platform 100 may host or enable engagement with content, posts, or derivative works of same. Online social collaboration platform 100 may present or display the content, posts, or derivative works of same in the form of one or more graph structures, where a unit of content, posts, derivative works of same, or associated data comprise a node in a graph structure and where associations between or amongst one or more nodes in the graph structure depict one or more associations between the content, posts, derivative works, or associated data. For example, a single post derived from multiple existing posts may be depicted as a single node in a graph structure having an association with each node depicting each said multiple existing posts.

For example, in some embodiments, web and graphic designers 200 may use the platform 100 to showcase their work and each work's variations to their clients. A graph structure may be presented to users 200 as a linear representation where all designs are displayed in a row. Clients or other users 200 may move back and forth between the designs to easily comment on and compare them.

In some embodiments, an artist 200 may use the platform 100 to allow others to view and make own amendments to the artist's 200 work. A first user device 200 may upload her artistic work to the platform 100 and set the work's privacy setting to public or viewable by one or more people including a second user device 200. The second user device 200 may engage with platform 100, navigate a graph structure to view the work uploaded by the first user device 200, and engage with an online editor associated with platform 100 to provide amendments to a copy of the work. The second user device 200 may set the privacy settings of her amended version of the first user device's 200 content as public or viewable by one or more people. Platform 100 may store the copy as a child or derivative node of the first user device's 200 content. Other users 200 may likewise view or provide amendments to the first user device's 200 content or provide amendments to the child or derivative node comprising the second user device's 200 amended version of the first user device's 200 content. Each subsequent child or derivative node created may store content or a post that may likewise be amended by one or more users 200. Each amended work may be stored in a child or derivative node of the node in the graph structure storing the content or post from which the amendment was made. This graph storage structure may enable user devices 200 to view associations between or amongst content or posts, for example, in a viewable graph structure, tree structure, slideshow, linear representation, or other presentation form. Users 200 may also engage with content or posts and understand associations between or amongst content or posts, for example, in a viewable combination of a slideshow depicting said content or posts and textual representations of the nature of any relationship between or amongst the content or posts.

In some embodiments, user devices 200 may use the platform 100 to demonstrate scientific work, for example, scientific work that may be presented as a tree or graph or scientific work where its use or engagement may be facilitated by, enabled by, or benefit from storage in a graph storage structure. For example, scientific work may include the result of an MRI scan, the tree of life, and the depictions or reports of growth of an embryo or a cell. In some embodiments, user devices 200 may use the platform 100 to demonstrate game walkthroughs or different game strategies in order to enable easier viewing of different resultant game endings. In some embodiments, user devices 200 may use the platform to show their blueprints and sketches to users of the platform in order to more easily solicit feedback and recommendations.

Platform 100 may allow users to submit new posts or content that are potentially related to many other existing posts or content. For example, a post submitted by a user device 200 may be a derivative of a large number of existing posts. One or more graph databases or one or more databases using graph data structures may be a more suitable and convenient choice for storing posts and the potentially large number of relationships among posts.

One or more graph databases 124 or relational databases 124 may support platform 100 and the storage of posts, content, or relationships between or amongst same. For example, relational databases may be suitable when the data is predictable, when the data fits well into tables, rows and columns, and when queries are not SQL JOIN intensive. A JOIN operation may combine columns from one or more tables. When content stored in a database becomes more interrelated, JOIN operations may become more complex. Such queries may be complex to construct and expensive to run. Execution of such queries in real-time web applications may cause an end user to wait for response, which consequently affects the user experience.

In contrast, a graph data model or one or more graph databases may represent the problem domain more intuitively and accurately. Relationships may be of priority in a graph database, that is, a graph database may be optimized for storing relationships. There may be no need to use foreign keys to infer relations (as is the case in a relational database) and the resulting data model may be much simpler and easier to understand than those produced by traditional relational or other types of databases. Each node in a graph structure may list relationship records that may represent or be used to represent the node's relationship to other nodes. These relationships may contain attributes, for example, type and direction. A JOIN operation on a graph database may use or return the list or a subset of the list of relationships instead of performing one or more expensive search or match computations, as may be performed by a relational database. The method of storage of relationships among nodes may allow the graph engine to provide performance of several orders of magnitude better than a relational database. Any such improvement over a relational database may become more evident as the amount of the data grows and multi-node traversal is made.

The platform 100 may present or allow visualization of nodes, posts, content, or derivative works of same as a graph or tree model. Storage of posts, content, or derivative works of same using one or more graph databases 124 or databases 124 using one or more graph storage structures may enable a more streamlined and convenient procedure to obtain and visualize nodes, posts, content, or derivative works of same and relationships between and amongst them. At any given time, a visualized graph data structure may represent a visual replica of how posts, content, derivative works of same, relationships between or amongst same, nodes, or edges are stored in the database 124. For example, while navigating a graph, if a user device 200 attempts to view a new child post, the platform 100 may simply send the identifier of the current node and obtain the next child node from the graph database. Accordingly, each node may be uniquely identified by an identifier.

In some embodiments, platform 100 may provide a modern and clutter free design with easy and intuitive search and navigation capabilities; an ability for user devices 200 to edit, tag, and annotate one or more posts, content, or derivative works of same with ease; an ability for users 200 to zoom in, zoom out, and view posts, content, or derivative works of same as a slideshow; an ability for users 200 to add or remove one or more posts, content, or derivative works of same to or from one or more graph storage structures or locations within one or more graph storage structures by dragging and dropping the posts, content, or derivative works of same to or from one or more representations of posts, content, or derivative works of same; an ability for users 200 to edit one or more while engaging with platform 100 via a browser or mobile application without downloading or locally saving the one or more posts; an ability for users 200 to download or upload one or more posts, content, or derivative works of same.

In some embodiments, platform 100 may be implemented to allow scalability and provide uninterrupted and high performance service to a large number of users 200.

In some embodiments, platform 100 may support privacy-related protection for user device 200 profiles; data relating to user device 200, user device 200 profiles, and user device 200 accounts; data relating to user device 200 engagement with platform 100; content, posts, or derivative works of same created by one or more users 200; and user device 200 accounts.

In some embodiments, platform 100 may support copyright-related options and settings for posts, content, or derivative works of same associated with one or more users 200.

In some embodiments, platform 100 may support security-related options and protection for user device 200 profiles, data relating to user device 200, user device 200 profiles, and user device 200 accounts; data relating to user device 200 engagement with platform 100; content, posts, or derivative works of same created by one or more users 200; and user device 200 accounts.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Various example embodiments are described herein. Although each embodiment represents a single combination of inventive elements, all possible combinations of the disclosed elements include the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

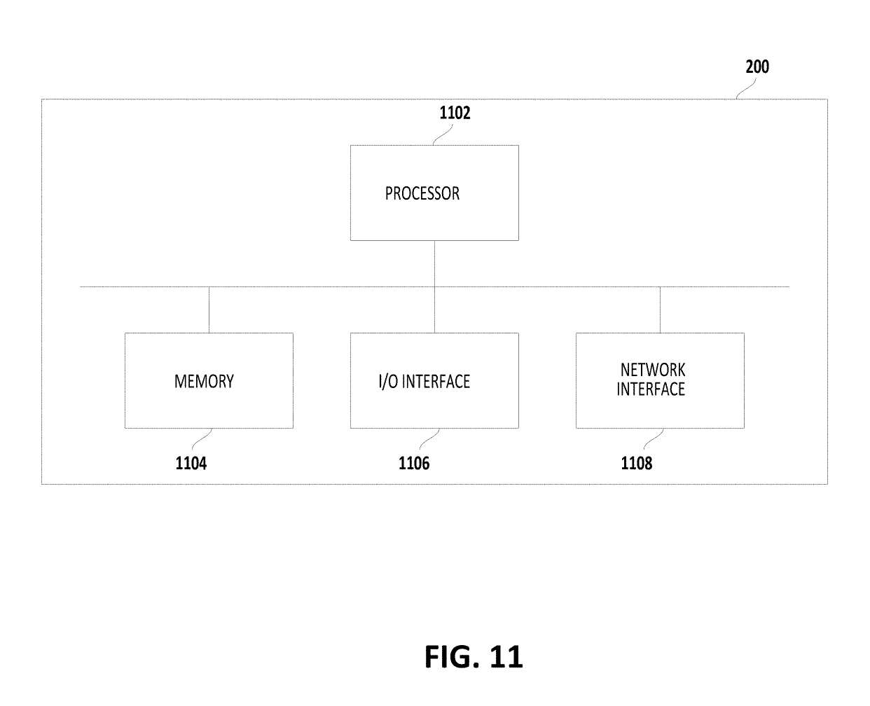

FIG. 11 is a schematic diagram of user device 200, exemplary of an embodiment. As depicted, computing device 200 includes at least one processor 1102, memory 1104, at least one I/O interface 1106, and at least one network interface 1108.

Each processor 1102 may be, for example, any type of general-purpose microprocessor or microcontroller, a digital signal processing (DSP) processor, an integrated circuit, a field programmable gate array (FPGA), a reconfigurable processor, or any combination thereof.

Memory 1104 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1106 enables computing device 200 to interconnect with one or more input devices, such as a keyboard, mouse, camera, touch screen and a microphone, or with one or more output devices such as a display screen and a speaker.

Each network interface 1108 enables computing device 102 to communicate with other components, to exchange data with other components, to access and connect to network resources, to serve applications, and perform other computing applications by connecting to a network (or multiple networks) capable of carrying data.

Computing device 102 is operable to register and authenticate users (using a login, unique identifier, and password for example) prior to providing access to platform 100, applications, a local network, network resources, other networks and network security devices. Computing devices 102 may serve one user or multiple users.

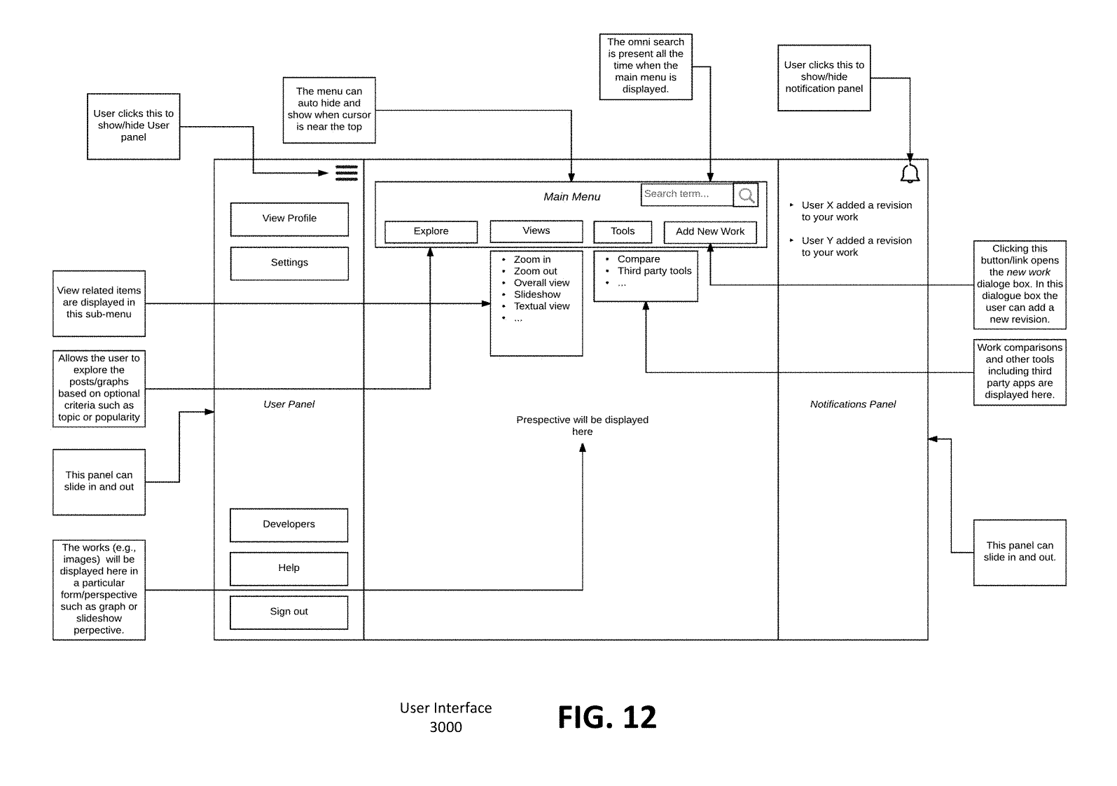

FIG. 12 is a diagram of an interface 3000 for online social content collaboration according to some embodiments described herein. Different example user interface elements are shown. A user interface element can be activated to trigger a workflow and activate associated functionality. Example user interface elements include explore, view, tools, and add new work. The interface 3000 includes different panels such as a user panel, menu panel and notifications panel.

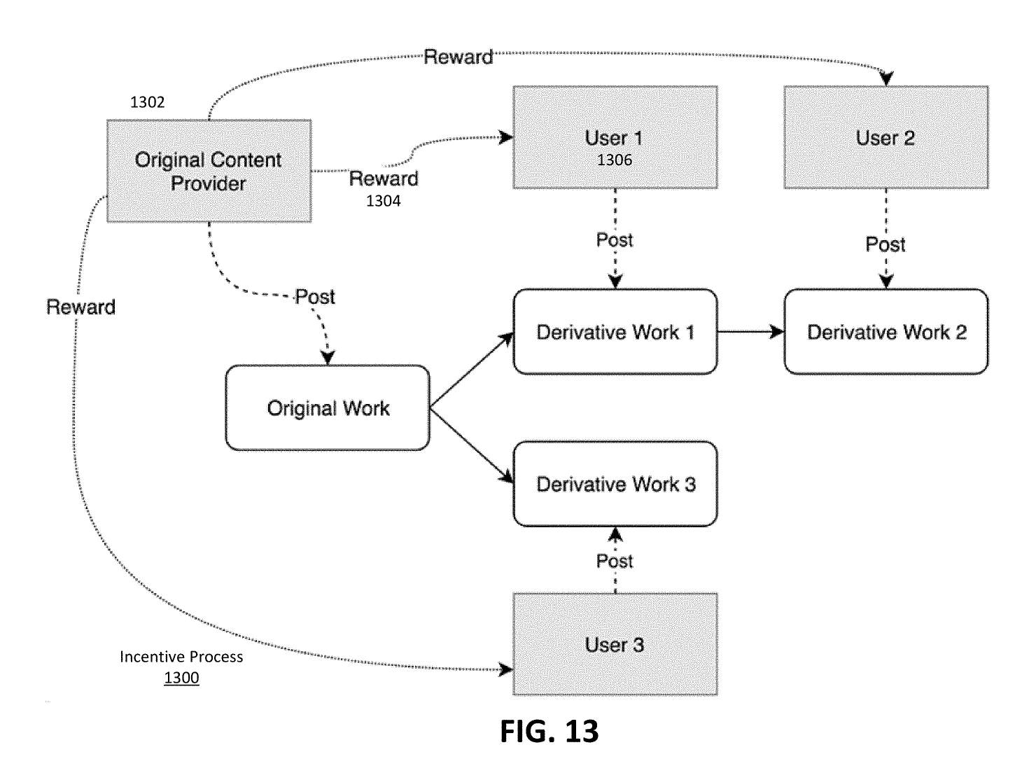

FIG. 13 is a diagram of a workflow for an example process 1300 for incentives.

In some embodiments, the online platform 100 can support a cryptographic token or “Virtual Coin” to incentivize contribution. These tokens can be purchased by the content request and offered to content producers, for example.

In an example, the original content provider 1302 begins by purchasing the tokens and starting a new tree structure by submitting an initial preliminary work. The provider can ask the community for new derivatives. Any new derivative is considered for reward in the form of tokens. Another user 1306 can post a derivative work and receive a reward 1304 of tokens. The original content provider 1302 can decide the amount of tokens for the reward 1304 and its terms and conditions. The amount of token given to every design submission can be based on many factors including, for example: the number of likes given by the community to the derivatives; the rating given by the community to the derivatives; the approval stamp given by the original content provide; the number of derivatives generated from each derivative; and so on. The type of cryptographic token used may be a custom token built specifically for the online platform 100, an existing currency, or a combination thereof.

In some embodiments, the online platform 100 involves artificial intelligence (AI) using rules. The online platform 100 provides Al based functionality and advanced image processing capabilities. The image processing features include: Image analytics and mining; Image Classification; Image Clustering; Object detection within images; Text detection within images; Metadata generation from images; Colors and patterns detection from images; Face detection in images; Image comparisons techniques: Pixelwise, Feature based, Hash, Perpetual Hashing; Production of transitions (i.e. interpolation) between multiple images; Image prediction to produce new derivatives from existing works; Image prediction by use of various Deep learning techniques, such as for example, Generative Adversarial Network (GAN), Convolutional Neural Network (CNN) and Variational AutoEncoder (VAE) to produce new derivatives from existing works. These are example techniques and others can be used. The new derivatives can be new work inheriting certain properties from the parent works such as: a duplicate of parent work rendered from a new angle; A derivative forecasted by analyzing the successive images in a time series; A derivative incorporating the visual elements of its parents; A 3D derivative produced from 2D work.

The online platform 100 can be used for licensing of works in some embodiments. The original content provider submitting the initial work sets the preferred license terms. This license can be applied to every new work added as a derivative to the original work. Users who wish to contribute to this tree must be able to view and accept the license agreement. The license can be custom defined or chosen from the existing licenses associated with creative works including ‘Public domain’ and ‘Creative Commons’.

The online platform 100 can be used for tracking ownership of works in some embodiments. The ownership of a work can be cryptographically guaranteed through different example methods.

### Example Method 1

Each content provider has a public and private cryptographic key. A hash of the work is generated and signed using the content provider's private key. The hash is then posted on existing blockchain systems, Alternatively the hash of the work can include the hash of the parent works to harden the relationships among them.

### Example Method 2

A watermark is added to the work representing the owner.

### Example Method 3

This method can involve implementing steganography to add hidden licensing and ownership details to the works.

Consider the following scenario as an example use case of how submissions are managed on the online platform 100:

Initially user A uploads her work to the online platform 100 and set its privacy to public. She also sets the license she wishes to use. User B is then able to view user A's work and provide his own amendments to it. The new changes are added as a child of user A's work. Other users can also use user B's changes as the basis of their work to create new derivatives of user B's work. The new changes are added as the children of user B's work.

The above example produces a tree structure for the works, which starts from user A's work (the root of the tree), followed by user B's work, followed by the rest of the submissions. This process can continue indefinitely and through this procedure a single idea can evolve into a variety of possibilities.

There are numerous example uses cases where a user interface with visual representation of a tree presentation of a collection of items is useful.

Graphic designers can use the platform to showcase their work and its variations to their clients. In this case the tree structure could have a linear structure where all designs are displayed in a row. Clients can move back and forth between the designs, and easily comment and compare them.

Scientists can use the platform to demonstrate any scientific work that can be shown as a tree (or graph). Examples include the result of an MRI scan, the tree of life, the growth of embryo or a cell.

Gamers can use the platform to demonstrate their games walkthroughs or various gaming strategies each of which may lead to a different game endings.

Architects and car designers can use the platform to show their blueprints and sketches to users of the platform and to get suggestions.

Although the embodiments have been described in detail, it should be understood that various changes, substitutions and alterations can be made herein without departing from the scope as defined by the appended claims. Moreover, the scope of the present application is not intended to be limited to the particular embodiments of the process, machine, manufacture, composition of matter, means, methods and steps described in the specification. The appended claims are intended to include within their scope such processes, machines, manufacture, compositions of matter, means, methods, or steps. The examples described above and illustrated are intended to be exemplary only.

What is claimed is:

1. An online social content collaboration platform comprising a processor and a memory storing computer executable instructions to configure the processor to:
receive or access content from a first user device;
create derivative work of the content in response to commands from a second user device;
store the derivative work at the memory;
generate a graph structure of first node for the content and a second node for the derivative work and a first edge between the first node for the content and the second node for the derivative work;
store the graph structure at the memory; and
generate an interface for display on a display device, the interface having visual elements representing the content, the derivative work, and the graph structure of the first node, the second node, and the first edge.

2. The online social content collaboration platform of claim 1, wherein the processor is further configured to receive a search request from the second user device and provide an indication of the content in response to the search request.

3. The online social content collaboration platform of claim 1, wherein the processor is further configured to:
create a second derivative work of the content in response to commands from a third user device;
store the second derivative work at the memory;
update the graph structure with a third node for the second derivative work and a second edge between the first node for the content and the third node for the second derivative work;
store the updated graph structure at the memory; and
update the interface with additional visual elements representing the second derivative work, and the updated graph structure with the third node, and the second edge.

4. The online social content collaboration platform of claim 1, wherein the processor is further configured to:
create a second derivative work of the derivative work in response to commands from a third user device;
store the second derivative work at the memory;
update the graph structure with a third node for the second derivative work and a second edge between the second node for the derivative work and the third node for the second derivative work;
store the updated graph structure at the memory; and
update the interface with additional visual elements representing the second derivative work, and the updated graph structure with the third node, and the second edge.

5. The online social content collaboration platform of claim 1, wherein the processor is further configured to:
receive a reward amount from the first user device as an incentive for the derivative work; and
distribute the reward amount to the second user in response to the creation of the derivative work.

6. The online social content collaboration platform of claim 1, wherein the processor is further configured to receive a first tag for the content and second tag the derivative work; and update the interface with additional visual elements for the first tag and the second tag.

7. The online social content collaboration platform of claim 1, wherein the processor is further configured to receive a first comment for the content and second comment the derivative work; and update the interface with additional visual elements for the first comment and the second comment.

8. The online social content collaboration platform of claim 1, wherein the processor is further configured to generate a first user profile linked to the content and a second user profile linked to the derivative work; update the graph structure with a first reference in the first node to the first user profile and a second reference in the second node to the second user profile.

9. The online social content collaboration platform of claim 1, wherein the processor is further configured to receive an update to the content and update the interface with the updated content.

10. The online social content collaboration platform of claim 1, wherein the processor is further configured to receive an update to the derivative work and update the interface with the updated derivative work.

11. The online social content collaboration platform of claim 1, wherein the processor is further configured to compare the content to the derivative work to generate comparison output and update the interface with an indication of the comparison output.

12. The online social content collaboration platform of claim 1, wherein the processor is further configured to receive interactions selected from: one or more of viewing the first edge between the content and the derivative work, searching for the content, comparing the content and the derivative work using a data processing tool, amending or modifying the content or the derivative work, creating content or the derivative work, commenting on the content or the derivative work, tagging the content or the derivative work with metadata, managing profile settings, and generating configurations for the interface to display different perspectives of the visual elements.

13. The online social content collaboration platform of claim 1, wherein each node in the graph structure includes an identifier for the content or the derivative work, user identifier for the user device that created the content or the derivative work, and time data for the creation of the content or the derivative work, wherein the first edge include an identifier for one or more parent nodes and an identifier for one or more child nodes in the graph structure.

14. An online social content collaboration process comprising:
at a processor, receiving or accessing content from a first user device;
creating derivative work of the content in response to commands from a second user device;
generating a graph structure of first node for the content and a second node for the derivative work and a first edge between the first node for the content and the second node for the derivative work;
storing the graph structure at a memory; and
generating an interface for display on a display device, the interface having visual elements representing the content, the derivative work, and the graph structure of the first node, the second node, and the first edge.

15. The process of claim 14 further comprising receiving a search request from the second user device and provide an indication of the content in response to the search request.

16. The process of claim 14 further comprising:
creating a second derivative work of the content in response to commands from a third user device;
updating the graph structure with a third node for the second derivative work and a second edge between the first node for the content and the third node for the second derivative work;
storing the updated graph structure at the memory; and
updating the interface with additional visual elements representing the second derivative work, and the updated graph structure with the third node, and the second edge.

17. The process of claim 14 further comprising:
creating a second derivative work of the derivative work in response to commands from a third user device;
storing the second derivative work at the memory;
updating the graph structure with a third node for the second derivative work and a second edge between the second node for the derivative work and the third node for the second derivative work;
storing the updated graph structure at the memory; and
updating the interface with additional visual elements representing the second derivative work, and the updated graph structure with the third node, and the second edge.

18. The process of claim 14 further comprising:
receiving a reward amount from the first user device as an incentive for the derivative work; and
distributing the reward amount to the second user in response to the creation of the derivative work.

19. The process of claim 14 further comprising receiving an update to the derivative work and updating the interface with the updated derivative work.
The process of claim 14 further comprising, comparing the content to the derivative work to generate comparison output and updating the interface with an indication of the comparison output.
